(19) United States
(12) Patent Application Publication
(10) Pub. No.: US 2006/0219273 A1
(43) Pub. Date: Oct. 5, 2006

(54) Substrate processing apparatus

(75) Inventor: Nobuharu Nagara, Kyoto (JP)

Correspondence Address: OSTROLENK FABER GERB & SOFFEN, 1180 AVENUE OF THE AMERICAS, NEW YORK, NY, 100368403, US

(73) Assignee: Dainippon Screen Mfg., Co., Ltd.

(21) Appl. No.: 11/392,043

(22) Filed: Mar. 29, 2006

(30) Foreign Application Priority Data
Mar. 29, 2005 (JP) JP2005-094287

(51) Int. Cl. B08B 3/04

(52) U.S. Cl. 134/56 R; 134/111; 134/57 R; 134/113; 134/108; 134/94.1; 134/100.1; 134/103.1

(57) ABSTRACT

In a solution change processing which comprises: changing a processing solution stored in a processing bath, specifically deionized water for sulfuric acid; and controlling the temperature of sulfuric acid so changed to a predetermined temperature, first, deionized water is discharged from a processing bath and an external bath. Subsequently, sulfuric acid is supplied from a supplying nozzle to the external bath. Subsequently, an upper circulating process is started by opening and closing a predetermined valve, while allowing a pump and a temperature controller be operated. At the time the temperature of a processing solution is higher than a predetermined value, an inside circulating process is carried out by opening and closing a predetermined valve, while having the pump and the temperature controller keep operating.

### BACKGROUND OF THE INVENTION

1. Field of the Invention

The present invention relates to a substrate processing apparatus that performs a predetermined processing by immersing a semiconductor substrate, a glass substrate for a liquid crystal display, a glass substrate for a photomask, a substrate for an optical disk, and the like (which are hereinafter referred to simply as a “substrate”) in a processing solution such as deionized water, a chemical solution or the like stored in a processing bath.

2. Description of the Background Art

Conventionally, there has been known a substrate processing apparatus that performs a predetermined processing by immersing a substrate in a processing solution stored in a processing bath.

In a conventional technique, a solution change processing, which comprises changing a processing solution stored in a processing bath of a substrate processing apparatus; and controlling the temperature of the changed processing solution to a temperature suitable for a substrate processing, is carried out in the following procedure.

First, (i) a processing solution in a processing bath, and (ii) a processing solution in an overflow solution recovering part are discharged to the outside of a substrate processing apparatus. Next, (iii) a new processing solution of nearly room temperature is supplied to the processing bath after the processing solutions in the processing bath and the overflow solution recovering part have been discharged. When supplying the new processing solution, the processing solution overflowing the processing bath is recovered by the overflow recovering part. Subsequently, (iv) after the new processing solution has been supplied, the temperature control of the processing solution is started while letting it circulate from an external bath to the processing bath. At the time a predetermined amount of the processing solution in the processing bath is controlled to a predetermined temperature, a substrate can be subjected to a substrate processing with the changed processing solution. Thus, the conventional solution change processing calls for the foregoing processing (i) to (iv).

However, the time required for the solution change processing becomes an issue in order to further improve the throughput of a substrate processing. For example, when a processing solution of nearly room temperature not subjected to preheating is supplied to a substrate processing bath, the time needed to control the processing solution to a predetermined temperature also becomes an issue.

### SUMMARY OF THE INVENTION

The present invention is directed to a substrate processing apparatus that carries out a processing of a substrate.

According to the present invention, a substrate processing apparatus that carries out a processing of a substrate includes a processing bath, an external bath, common piping, first piping, second piping, a switching part, a temperature controller, a filter, a temperature measuring part, and a controller. The processing bath can store a processing solution and contain a substrate. The external bath is disposed outside of the processing bath and recovers the processing solution overflowing the processing bath. The common piping is used to discharge the processing solution from the external bath. The first piping is connected to the common piping and supplies to the processing bath the processing solution discharged via the common piping. The second piping is connected to the common piping and supplies to the processing bath the processing solution discharged via the common piping. The switching part causes a flow of the processing solution to be switched between the first piping and the second piping. The temperature controller is disposed on the common piping and controls the temperature of the processing solution flowing through the common piping. The filter is disposed on the second piping. The temperature measuring part measures the temperature of the processing solution. The controller, when a temperature of the processing solution measured by the temperature measuring part is not greater than a predetermined temperature, controls the switching part so that the processing solution is supplied from the common piping to the processing bath via the first piping, while causing the temperature controller to heat the processing solution, and, when a temperature of the processing solution measured by the temperature measuring part exceeds a predetermined value, controls the switching part so that the processing solution is supplied from the common piping to the processing bath via the second piping, while causing the temperature controller to heat the processing solution.

This permits a reduction in the time needed to control a processing solution circulated from the external bath to the processing bath to a predetermined temperature.

Preferably, the switching part has a first valve disposed on the first piping and a second valve disposed on the second piping, and the controller controls open and close states of the first valve and the second valve.

This enables the supply of a processing solution to be reliably switched between the first piping and the second piping.

According to one aspect of the present invention, a substrate processing apparatus that carries out a processing of a substrate includes, a processing bath, an external bath, a processing solution supplying part, common piping, first piping, second piping, a switching part, a temperature controller, a filter, a storage amount detecting part, and a controller. The processing bath can store a processing solution and contain a substrate. The external bath is disposed outside of the processing bath and recovers the processing solution overflowing the processing bath. The processing solution supplying part supplies the processing solution to the external bath. The common piping is used to discharge the processing solution from the external bath. The first piping is connected to the common piping and supplies to the processing bath the processing solution discharged via the common piping. The second piping is connected to the common piping and supplies the processing solution discharged via the common piping to the processing bath. The switching part causes a flow of the processing solution to be switched between the first piping and the second piping. The temperature controller is disposed on the common piping and controls the temperature of the processing solution flowing through the common piping. The filter is disposed on the second piping. The storage amount detecting part detects an amount of storage of the processing solution stored in the external bath. The controller, when an amount of storage of the processing solution detected by the storage amount detecting part is not greater than a predetermined amount, controls the switching part so that the processing solution is supplied from the common piping to the processing bath via the first piping, while causing the temperature controller to heat the processing solution, and, when an amount of storage of the processing solution detected by the storage amount detecting part exceeds a predetermined value, controls the switching part so that a processing solution is supplied from the common piping to the processing bath via the second piping, while causing the temperature controller to heat the processing solution.

This permits a reduction in the time needed to control a processing solution circulated from the external bath to the processing bath to a predetermined temperature.

According to other aspect of the present invention, a substrate processing apparatus that carries out a processing of a substrate includes a processing bath, an external bath, a processing solution supplying part, a supply amount measuring part, common piping, first piping, second piping, a switching part, a temperature controller, a filter, and a controller. The processing bath can store a processing solution and contain a substrate. The external bath is disposed outside of a processing bath and recovers the processing solution overflowing the processing bath. The processing solution supplying part supplies the processing solution to the external bath. The supply amount measuring part measures an amount of supply of the processing solution supplied from the processing solution supplying part to the processing bath. The common piping is used to discharge the processing solution from the external bath. The first piping is connected to the common piping and supplies to the processing bath the processing solution discharged via the common piping. The second piping is connected to the common piping and supplies to the processing bath the processing solution discharged via the common piping. The switching part causes a flow of the processing solution to be switched between the first piping and the second piping. The temperature controller is disposed on the common piping and controls the temperature of the processing solution flowing through the common piping. The filter is disposed on the second piping. The controller when an amount of supply of the processing solution measured by the supply amount measuring part is not greater than a predetermined amount, controls the switching part so that the processing solution is supplied from the common piping to the processing bath via the first piping, while causing the temperature controller to heat the processing solution, and, when an amount of supply of the processing solution measured by the supply amount measuring part exceeds a predetermined value, controls the switching part so that the processing solution is supplied from the common piping to the processing bath the second piping, while causing the temperature controller to heat the processing solution.

This permits a reduction in the time needed to control a processing solution circulated from the external bath to the processing bath to a predetermined temperature.

Accordingly, an object of the present invention is to provide a substrate processing apparatus capable of further improving the throughput of a substrate processing that is carried out by immersing a substrate in the processing solution stored in a processing bath.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing one example of the construction of a substrate processing apparatus according to a first, a second, or a third preferred embodiment of the present invention;

FIG. 2 is a timing chart for the purpose of explaining a solution change processing of a processing solution in the first preferred embodiment;

FIG. 3 is a diagram for the purpose of explaining the timing to start an upper circulating process and the operation of a temperature controller;

FIG. 4 is a timing chart for the purpose of explaining a solution change processing of a processing solution in the second or third preferred embodiment;

FIG. 5 is a diagram for the purpose of explaining a timing of switching from the upper circulating process to the inside circulating process;

FIG. 6 is a diagram for the purpose of explaining one example of the construction of a substrate processing apparatus according to a fourth preferred embodiment of the present invention; and

FIG. 7 is a timing chart for the purpose of explaining a solution change processing of a processing solution in the fourth preferred embodiment.

### DESCRIPTION OF THE PREFERRED EMBODIMENTS

Preferred embodiments of the present invention will be described below with reference to the accompanying drawings.

### 1. First Preferred Embodiment

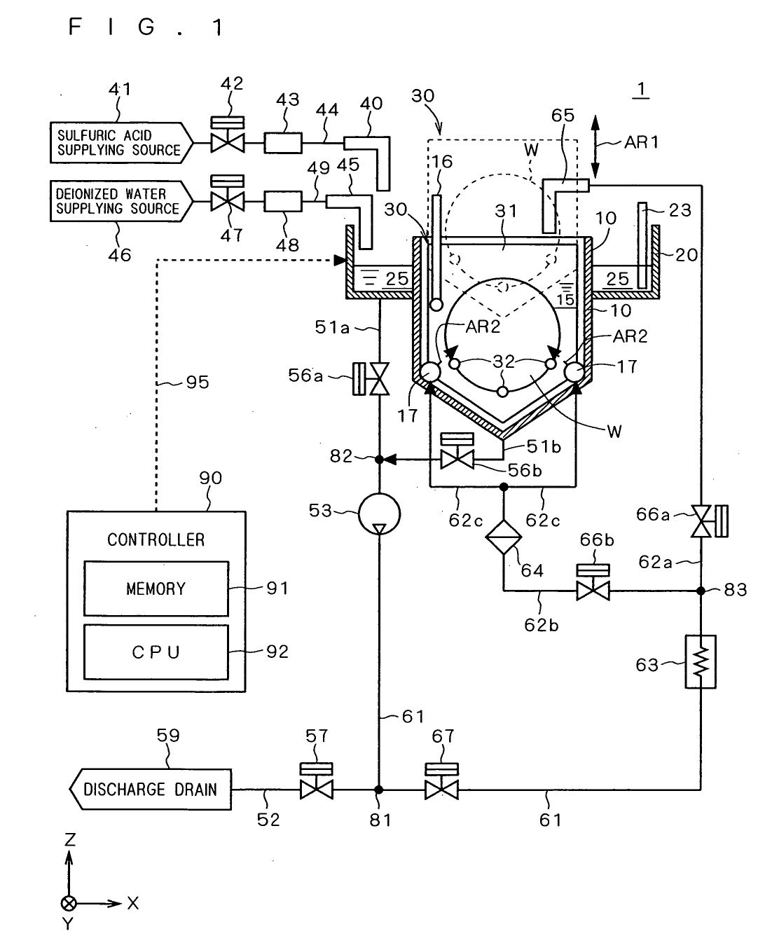

FIG. 1 is a diagram showing one example of the construction of a substrate processing apparatus 1 according to a first preferred embodiment of the present invention. The substrate processing apparatus 1 is a so-called “batch processing” apparatus, which performs a substrate processing of a plurality of substrates at one time. As shown in FIG. 1, the substrate processing apparatus 1 consists mainly of a processing bath 10, an external bath 20 that is disposed outside of the processing bath 10 and recovers a processing solution overflowing the processing bath 10, piping 51a, 61, 62a to 62c, through which a processing solution discharged from the external bath 20 is resupplied to the processing bath 10, and valves 66a and 66b that are provided in corresponding piping and set a passage of a processing solution to be resupplied from the external bath 20.

The processing bath 10 stores on its inside a processing solution 15. By allowing a plurality of substrates W to be immersed in the processing solution 15, the substrates W are subjected to a processing such as cleaning and etching. Disposed in the vicinity of the bottom on the inside of the processing bath 10 are two second processing solution nozzles 17 extending in the Y-axis direction. The processing solution discharged from the external bath 20 is supplied from the second processing solution nozzles 17 via the piping 51a, 61, 62b, and 62c, into the processing bath 10, as indicated by the arrows AR2. Further disposed on the inside of the processing bath 10 is a temperature meter 16 that measures the temperature of the processing solution 15 stored in the processing bath 10.

An elevating mechanism 30 is a mechanism to immerse a plurality of substrates W in a processing solution stored in the processing bath 10. As shown in FIG. 1, the elevating mechanism 30 consists mainly of a lifter 31, and holding bars 32. The lifter 31 is disposed such that it can move up and down in the Z-axis direction as indicated in the arrows AR1. Attached to the lifter 31 are three holding bars 32 extending along the Y-axis direction. Here, the three holding bars 32a are provided with a plurality of holding grooves (not shown), respectively. A substrate W can be held in its standing position by letting its outer edge fit into a corresponding holding groove.

Accordingly, the plurality of substrates W held by the three holding bars 32 are moved up and down by the lifter 31 to thereby move up and down between a position to be immersed in the processing solution 15, and an upper position of the processing bath 10 where they are transferred to and from a transport robot (not shown).

Above the outside of the processing bath 10, the external bath 20 is disposed so as to surround an upper end of the processing bath 10, as shown in FIG. 1. This allows the processing solution overflowing the processing bath 10 to be recovered by the external bath 20.

Supplying nozzles 40 and 45 are disposed above the external bath 20. As shown in FIG. 1, the supplying nozzle 40 is connected in communication to a sulfuric acid supplying source 41 via a valve 42, a flow meter 43, and piping 44. The supplying nozzle 45 is connected in communication to a deionized water supplying source 46 via a valve 47, a flow meter 48, and piping 49. Controlling the open and close states of the valves 42 and 47 causes the supplying nozzles 40 and 45 to supply sulfuric acid and deionized water to the external bath 20 from above the external bath 20, respectively.

The flow meters 43 and 48, which are disposed on the piping 44 and 49 as shown in FIG. 1, measure the flow rate per unit time of sulfuric acid supplied from the sulfuric acid supplying source 41, and that of deionized water supplied from the deionized water supplying source 46, respectively. From the detected values of the flow meters 43 and 48, the amounts of sulfuric acid and deionized water supplied to the external bath 20 can be calculated, respectively.

As shown in FIG. 1, further disposed on the inside of the external bath 20 is a level sensor 23 that can detect the height of liquid level of the processing solution 25 recovered by the external bath 20. Since the internal configuration of the external bath 20 is known from its design, the storage capacity can be calculated from the height of liquid level of a processing solution. In other words, the amount of storage of a processing solution and the height of liquid level of the processing solution is a one-to-one correspondence. Therefore in the first preferred embodiment, a predetermined processing is carried out based on the height of liquid level of a processing solution that is a detection result of the level sensor 23, or the amount of storage calculated from a detection result of the level sensor 23.

An internal region of the external bath 20 is connected in communication to a first discharge pipe 51a. A valve 56a that can be opened and closed is disposed on the first discharge pipe 51a. The first discharge pipe 51a is connected in communication to the common piping 61 at a communication position 82. Further, connected at the communication position 82 is a second discharge pipe 51b connecting to an internal region of the processing bath 10 and joining to a valve 56b that can be opened and closed.

The common piping 61 is used mainly to supply the processing solution 25 discharged from the external bath 20 to the processing bath 10. As shown in FIG. 1, the common piping 61 is provided with a pump 53, a valve 67, and a temperature controller 63, in this order from the external bath 20 (the position 82) side to the processing bath 10 (the position 83) side. The common piping 61 is also connected at the communication position 83 to first piping 62a and second piping 62b, respectively.

The first piping 62a is piping through which the processing solution introduced by the common piping 61 is supplied from above the processing bath 10. As shown in FIG. 1, a valve 66a that can be opened and closed is joined to the first piping 62a, and a first processing solution nozzle 65 located above the processing bath 10 is connected in communication to the end on the opposite side of the communication position 83 of the first piping 62a.

On the other hand, the second piping 62b is piping through which the processing solution introduced by the common piping 61 is supplied from the inside of the processing bath 10. As shown in FIG. 1, the second piping 62b is provided with a valve 66b and a filter 64, in this order from the communication position 83 side to the processing bath 10 side. The end of the second piping 62b on the opposite side of the communication position 83 is branched into two. Two second piping 62c so branched are connected to corresponding second processing nozzles 17, respectively.

Accordingly, by allowing the pump 53 to be driven, the valves 56a, 67 and 66a to be opened, and the valves 56b, 66b, and a valve 57 (described later) to be closed, the processing solution 25 recovered by the external bath 20 can be supplied to the processing bath 10 via the first discharge pipe 51a, the common piping 61, the temperature controller 63, the first piping 62a, and the first processing solution nozzle 65.

On the contrary, by allowing the pump 53 to be driven, the valves 56a, 67 and 66b to be opened, and the valves 56b, 57 and 66a to be closed, the processing solution 25 recovered by the external bath 20 can be discharged in the direction of the arrow AR2 and supplied to the inside of the processing bath 10 via the first discharge pipe 51a, the common piping 61, the temperature controller 63, the second piping 62b and 62c, and the second processing solution nozzles 17.

Thus, the substrate processing apparatus 1 of the first preferred embodiment performs two circulating processes of a processing solution, namely (i) a process in which a processing solution discharged from the external bath 20 is supplied and circulated from above the processing bath 10 to the processing bath 10 (hereinafter also referred to as an “upper circulating process”); and (ii) a process in which it is supplied and circulated from the inside of the processing bath 10 to the processing bath 10 (hereinafter also referred to as an “inside circulating process”).

When the processing solution used in a substrate processing is discarded as a processing solution to be discharged in the substrate processing apparatus 1 of the first preferred embodiment, this processing solution to be discharged is drained to a discharge drain 59 that is placed outside of the substrate processing apparatus 1, and is used as a common facility in a semiconductor factory.

Specifically, the first discharge pipe 51a communicating with the inside region of the external bath 20, and the second discharge pipe 51b communicating with the internal region of the processing bath 10 are communicated with the common piping 61 at the position 82. The third discharge pipe 52 is communicated with the common piping 61 at a position 81 that is located downstream of the communication position 82, and interposed between the pump 53 and the valve 67. The third discharge pipe 52 is provided with a valve 57 that can be opened and closed, and its end on the opposite side of the communication position 81 is connected in communication to the discharge drain 59.

Therefore, by allowing the pump 53 to be driven, the valves 56a and 57 to be opened, and the valves 56b and 67 to be closed, the processing solution 25 recovered by the external bath 20 can be drained to the discharge drain 59 via the first discharge pipe 51a, the common piping 61 and the third discharge pipe 52. Similarly, by allowing the pump 53 to be driven, the valves 56b and 57 to be opened, and the valves 56a and 67 to be closed, the processing solution 15 stored in the processing bath 10 can be drained to the discharge drain 59 via the second discharge pipe 51b, the common piping 61, and the third discharge pipe 52. By allowing the valves 66a, 66b, 67 and 57 to be opened, and the valves 56a, 56b and 66b to be closed, the processing solutions remaining in the common piping 61, the first piping 62a, and the second piping 62b and 62c can be drained under their own weights to the discharge drain 59.

The temperature controller 63 is located downstream of the valve 67 on the common piping 61, as shown in FIG. 1. The temperature controller 63 performs temperature control by raising the temperature of a processing solution flowing through the common piping 61.

The filter 64, which is disposed on the second piping 62b, eliminates particles, etc. contained in a processing solution flowing through the second piping 62b, as shown in FIG. 1.

The controller 90 includes a memory 91 that stores a program, variables and etc., and a CPU 92 that executes control under the program stored in the memory 91. The valves 42, 47, 56a, 56b, 57, 66a, 66b and 67, the pump 53, and the temperature controller 63, which are to be controlled by the controller 90, are electrically connected by a signal line 95.

Hence, the CPU 92 executes at a predetermined timing the opening and closing control of the valves 42, 47, 56a, 56b, 57, 66a, 66b and 67, and the driving control of the pump 53 and the temperature controller 63, under the program stored in the memory 91.

1.2. Procedure of Solution Change Processing

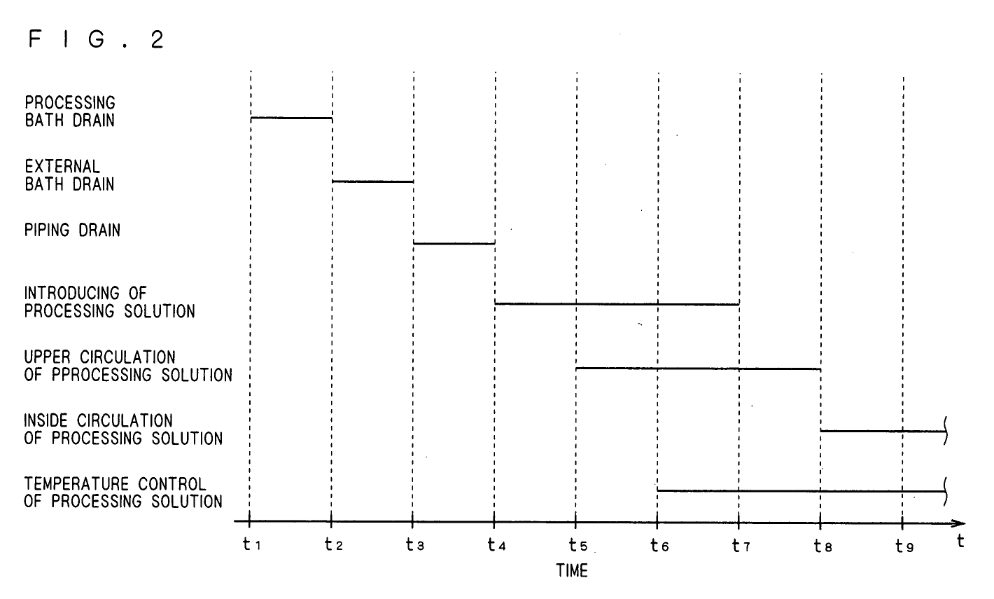

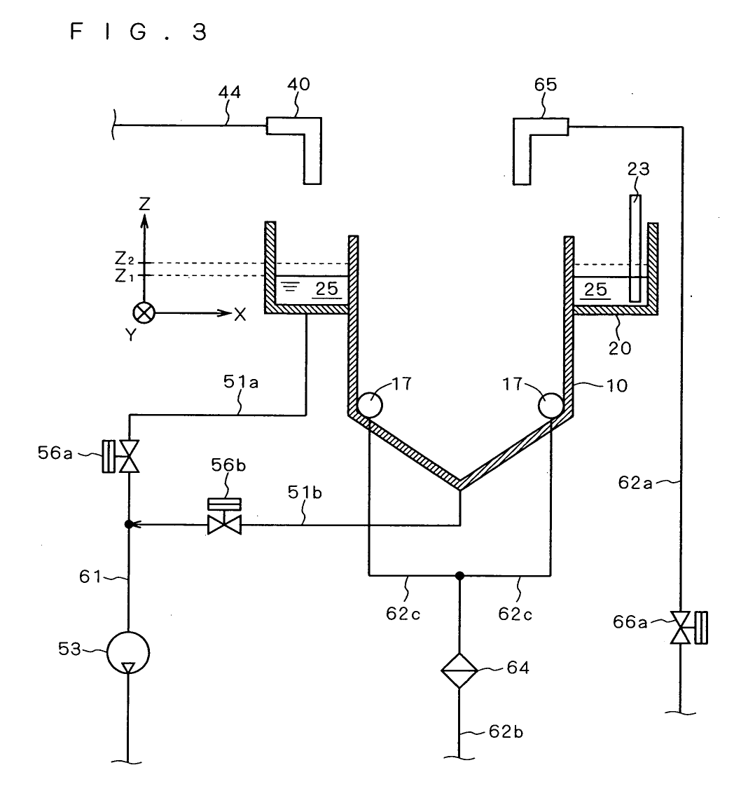

FIG. 2 is a timing chart for the purpose of explaining the change processing of a processing solution in the first preferred embodiment. FIG. 3 is a diagram for the purpose of explaining the upper circulating process, and an operation start timing of the temperature control process by the temperature controller 63. Referring now to FIGS. 1 to 3, the procedure of the solution change processing will be described.

The following is the process of changing deionized water stored in the processing bath 10 at any point before time t1 for sulfuric acid. Assuming that, at the point before time t1 in FIG. 2, the substrate W has been moved up and down in the Z-axis direction and transferred to a transport robot (not shown) by the elevating mechanism 30; and that the temperature of sulfuric acid supplied to the external bath 20 is nearly room temperature.

At time t1, the operation of the pump 53 is started, and the valves 56b and 57 are opened, and the valves 56a and 67 are closed. By allowing the pump 53 to be driven, the deionized water 15 stored in the processing bath 10 can be drained to the discharge drain 59 via the second discharge pipe 51b, the common piping 61 and the third discharge piping 52 (This is called “processing bath drain”).

At time t2, the valve 56b is closed and the valve 56a is opened, while maintaining the open/close states of the valves 57 and 67, and the operating state of the pump 53. By allowing the pump 53 to be driven, the deionized water 25 recovered by the external bath 20 can be drained to the discharge drain 59 via the first discharge pipe 51a, the common piping 61 and the third discharge pipe 52 (This is called “external bath drain”).

At time t3, the operation of the pump 53 is stopped, the valves 56a and 56b are closed, and the valves 67, 66a and 66b are opened, while maintaining the open state of the valve 57. This enables the deionized water remaining in the first piping 62a and the second piping 62b and 62c to be drained under its own weight to the discharge drain 59 via the common piping 61 and the third discharge pipe 52 (This is called “piping drain”).

At time t4, by allowing at least the valves 56a and 56b to be closed, and the valve 42 to be opened, the sulfuric acid of the sulfuric acid supplying source 41 can be supplied from the supplying nozzle 40 via the piping 44 to the external bath 20, so that the sulfuric acid is stored in the external bath 20. The supply of sulfuric acid is continued until time t7, at which the necessary amount of supply required for a substrate processing is completed.

At time t5, at which it is judged that the height Z of liquid level of the sulfuric acid stored in the external bath 20 reached Z1 (the liquid level indicated by the solid line in FIG. 3), based on a detected value of the level sensor 23, the valves 56a, 67 and 66a are opened and the operation of the pump 53 is started, while maintaining the close states of the valves 56b, 57 and 66b. Thereby, the sulfuric acid 25 stored in the external bath 20 can be supplied from the first processing solution nozzle 65 to the processing bath 10 via the first discharge pipe 51a, the common piping 61 and the first piping 62a. That is, the upper circulating process is started at time t5.

As shown in FIG. 2, after the upper circulating process is started, the valve 42 remains opened, permitting the supply of sulfuric acid to the external bath 20 to be continued. Hence, the supply of sulfuric acid discharged from the external bath 20 can be continuously supplied to and stored in the processing bath 10. The height Z1 of liquid level of sulfuric acid, which becomes trigger to start the upper circulating process, is previously found by experiment.

Subsequently, at time t6, at which it is judged that the height Z of liquid level of the sulfuric acid stored in the external bath 20 reached Z2 (the liquid level indicated by the dotted line in FIG. 3), based on a detected value of the level sensor 23, the operation of the temperature controller 63 is started, while allowing the upper circulating process to be effected. Thereby, the temperature control process by the temperature controller 63 is started to control the temperature of sulfuric acid flowing through the common piping 61.

After the temperature control process is started, the valve 42 remains opened, permitting the supply of sulfuric acid to the processing bath 10 to be continued. If the amount of sulfuric acid supplied from the external bath 20 to the processing bath 10 exceeds a maximum storage capacity of the processing bath 10, sulfuric acid overflows the processing bath 10, and it is recovered by the external bath 20.

Subsequently, at time t7, at which it is judged that the temperature of the sulfuric acid 15 stored in the processing bath 10 became greater than a predetermined value, based on a detected value of the temperature meter 16, the valve 66a is closed and the valve 66b is opened, while maintaining the open states of the valves 56a and 67, the close states of the valves 56b and 57, and the operating states of the pump 53 and the temperature controller 63.

This enables the sulfuric acid 25 discharged from the external bath 20 to be introduced from the second processing nozzle 17 to the inside of the processing bath 10 via the first discharge pipe 51a, the common piping 61 and the second piping 62b and 62c. That is, the process of circulating sulfuric acid from the external bath 20 to the processing bath 10 is switched from the upper circulating process to the inside circulating process.

It is known that, when a processing solution such as sulfuric acid is allowed to pass through the filter 64, as the temperature of the processing solution is raised, the flow resistance of the processing solution when it passes through the filter is lowered to thereby increase the circulation velocity of the processing solution.

The present invention has been achieved by taking aim at the relationship between the temperature of a processing solution and the flow resistance of the filter 64. That is, in the circulating process of the processing solution, the upper circulating process without passing through the filter 64 is effected in such a temperature range that the temperature of a processing solution is low and hence the flow resistance of the filter 64 is high, whereas the inside circulating process via the filter 64 is effected in such a temperature range that the heat transmitted from the temperature controller 63 raises the temperature of a processing solution, thereby lowering the flow resistance of the filter 64.

With this construction, from the point of view of the overall solution change processing, the flow resistance of sulfuric acid exerted by the filter 64 can be reduced to thereby increase the circulation velocity of sulfuric acid. This permits a reduction in the time needed to raise the temperature of sulfuric acid supplied to the external bath 20 to a predetermined value, allowing for a reduction in the time required for the solution change processing. Additionally, since the circulating process without passing through the filter 64 can be effected in the solution change processing, the lifetime of the filter 64 can be increased than that of a conventional substrate processing apparatus.

In the first preferred embodiment, in consideration of the temperature at which a substrate processing with sulfuric acid is carried out (about 120° C.), and the flow resistance of sulfuric acid, the circulating process of sulfuric acid is carried out by the upper circulating process when the temperature of sulfuric acid is 80° C. and below, and the inside circulating process when it is higher than 80° C. That is, in accordance with the first preferred embodiment, switching of the two circulating processes is induced by a temperature of 80° C. as a threshold value.

By continuing the inside circulating process, the solution change processing is completed at time t9, at which the temperature of the sulfuric acid 15 stored in the processing bath 10 has been raised to a temperature enabling a substrate processing (for example, about 120° C.).

Even at the point after time t9, at which a substrate processing is carried out after the solution change processing, the inside circulating process is continuously carried out. Thereby, the sulfuric acid overflowing the processing bath 10 is recovered by the external bath 20 and then discharged from the external bath 20. At this time, the temperature controller 63 provided on a circulation path transmits thermal energy to sulfuric acid, so that the sulfuric acid can be retained at a predetermined temperature.

The inside circulating process via the filter 64 is employed when a substrate processing is carried out in the processing bath 10. This enables the filter 64 to remove contaminant such as particles contained in sulfuric acid, so that the substrate processing is carried out satisfactorily.

1.3. Advantages of Substrate Processing Apparatus of First Preferred Embodiment

Thus, in the substrate processing apparatus 1 of the first preferred embodiment, based on the temperature of sulfuric acid, specifically in such a temperature range that sulfuric acid passing through the filter 64 has a high flow resistance, sulfuric acid can be circulated while being subjected to temperature control by the upper circulating process without passing through the filter 64. In such a temperature range that sulfuric acid has a low flow resistance, and when a substrate processing is carried out, sulfuric acid can be circulated while being subjected to temperature control by the inside circulating process via the filter 64.

With this construction, from the point of view of the overall solution change processing, the flow resistance of sulfuric acid exerted by the filter 64 can be reduced to thereby increase the circulation velocity of sulfuric acid. This permits a reduction in the time need to control the temperature of sulfuric acid to a predetermined value, allowing for a reduction in the time required for the solution change processing.

When a substrate processing such as cleaning process is carried out in the processing bath 10, the filter 64 can remove contaminant such as particles contained in sulfuric acid. Hence, clean sulfuric acid can be reintroduced into the processing bath 10, so that the substrate processing is carried out satisfactorily.

### Second Preferred Embodiment

A second preferred embodiment of the present invention will be described below. A substrate processing apparatus of the second preferred embodiment and that of the first preferred embodiment have similar hardware configurations and different procedures of the solution change processing. Other procedure of the solution change processing will now be described.

2.1. Procedure of Solution Change Processing

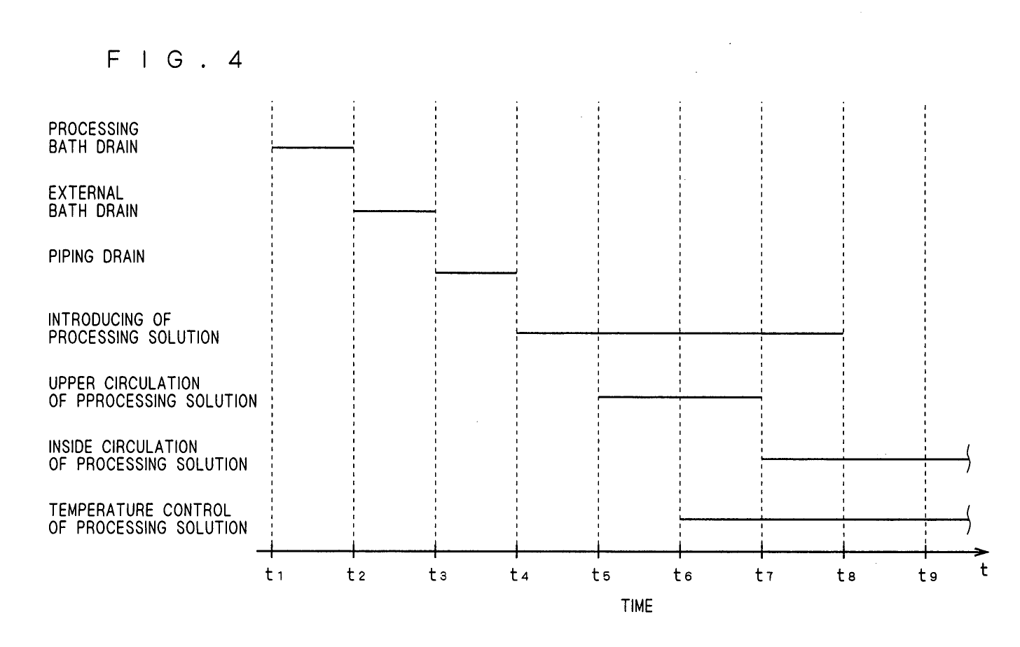

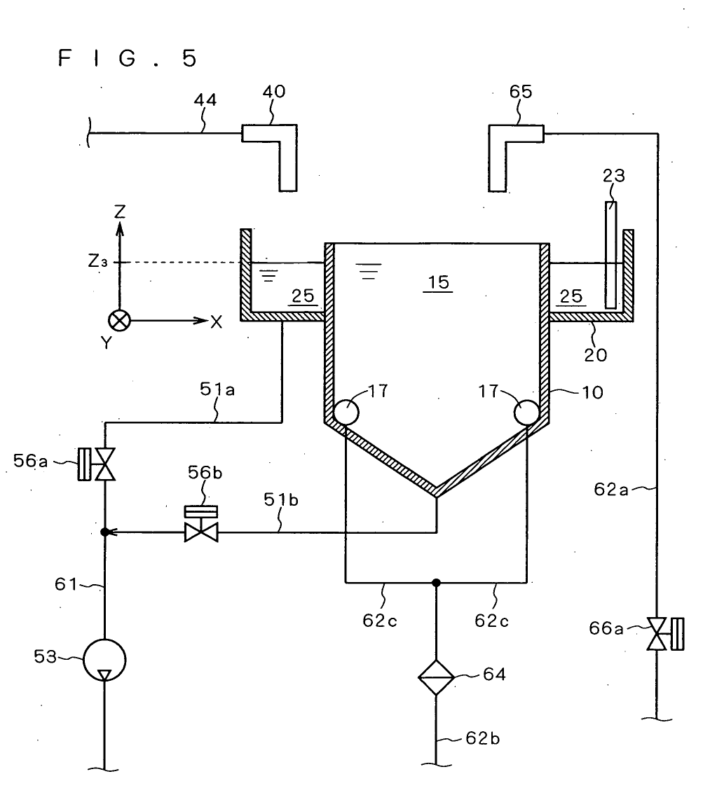

FIG. 4 is a timing chart for the purpose of explaining a solution change processing of a processing solution in the second preferred embodiment. FIG. 5 is a diagram for the purpose of explaining a timing to switch from the upper circulating process to the inside circulating process. The procedure of the solution change processing will be described below by mainly referring to FIGS. 4 and 5.

The following is a process of changing deionized water stored in the processing bath 10 for sulfuric acid at the point before time t1. Assuming that, at the point before time t1 in FIG. 4, a substrate W has been moved up and down in the Z-axis direction and transferred to a transport robot (not shown) by an elevating mechanism 30; and that the temperature of sulfuric acid supplied to an external bath 20 is nearly room temperature.

Like the first preferred embodiment, in a solution change processing, deionized water 15 stored in a processing bath 10 is drained at time t1 to t2, deionized water 25 recovered by the external bath 20 is drained at time t2 to t3, and deionized water remaining in first piping 62a and second piping 62b and 62c are drained at time t3 to t4, to a discharge drain 59, respectively.

Subsequently, at time t4, the sulfuric acid of a sulfuric acid supplying source 41 is supplied from a supplying nozzle 40 via piping 44 to the external bath 20, so that sulfuric acid can be stored in the external bath 20. The supply of sulfuric acid is continued until time t8, at which the necessary amount of supply for a substrate processing is completed.

Subsequently, like the first preferred embodiment, the above-mentioned upper circulating process is started at time t5, at which it is judged that the height Z of liquid level of the sulfuric acid stored in the external bath 20 reached Z1 (the liquid level indicated by the solid line in FIG. 3), based on a detected value of a level sensor 23. Temperature control process by a temperature controller 63 is started at time t6, at which it is judged that the height Z of liquid level of the sulfuric acid stored in the external bath 20 reached Z2 (the liquid level indicated by the dotted line in FIG. 3), based on a detected value of the level sensor 23.

After the temperature control process is started, the supply of sulfuric acid to the external bath 20 is continued, and the upper circulating process is also continued. If the amount of sulfuric acid supplied from the external bath 20 to the processing bath 10 exceeds a maximum storage capacity of the processing bath 10, sulfuric acid overflows the processing bath 10, and it is recovered by the external bath 20.

At time t7, at which it is judged that the height Z of liquid level of sulfuric acid stored in the external bath 20 reached Z3 (see FIG. 5), based on a detected value of the level sensor 23, the process of circulating sulfuric acid from the external bath 20 to the processing bath 10 is switched from the upper circulating process to the inside circulating process.

In the case where the flow rate per unit time of sulfuric acid supplied from a sulfuric acid supplying source 41, the circulation velocity of sulfuric acid by a pump 53, and the amount of heat supplied per unit time from the temperature controller 63 are predetermined, it is possible to find a certain correspondence between the height of liquid level of the sulfuric acid 25 that is supplied from the sulfuric acid supplying source 41, and overflows the processing bath 10 and is stored in the external bath 20 (or the storage capacity of sulfuric acid stored in the external bath 20), and the temperature of sulfuric acid stored in the processing bath 10.

Consequently, the present invention has been achieved by taking aim at (i) the relationship between the temperature of the sulfuric acid 15 stored in the processing bath 10, and the height of liquid level of the sulfuric acid 25 stored in the external bath 20; and (ii) the relationship between the temperature of the sulfuric acid 15 stored in the processing bath 10, and the flow resistance when the sulfuric acid 15 passes through a filter 64.

Specifically, in the second preferred embodiment, the upper circulating process without passing through the filter 64 is carried out in the case of the height of liquid level Z corresponding to such a temperature range that the flow resistance of sulfuric acid is high (namely when the height of liquid level is not more than Z3). On the other hand, the inside circulating process via the filter 64 is carried out in the case of the height of liquid level Z corresponding to such a temperature range that the flow resistance of sulfuric acid is low (namely when the height of liquid level is higher than Z3).

Like the first preferred embodiment, in the solution change processing, the flow resistance of sulfuric acid exerted by the filter 64 can be reduced to thereby increase the circulation velocity of sulfuric acid. This permits a reduction in the time needed to raise the temperature of sulfuric acid supplied to the external bath 20 to a predetermined value, allowing for a reduction in the time required for the solution change processing.

By continuing the inside circulating process, the solution change processing is completed at time t9, at which the temperature of the sulfuric acid 15 stored in the processing bath 10 has been raised to a temperature enabling a substrate processing.

Even at the point after time t9, at which a substrate processing is carried out after the solution change processing, the inside circulating process is continuously carried out. This enables the sulfuric acid overflowing the processing bath 10 to be recovered by the external bath 20 and then discharged from the external bath 20. At this time, the temperature controller 63 disposed on a circulation path transmits thermal energy to sulfuric acid, so that the sulfuric acid can be retained at a predetermined temperature.

The inside circulating process via the filter 64 is employed when a substrate processing is carried out in the processing bath 10. This enables the filter 64 to remove contaminant such as particles contained in sulfuric acid, so that the substrate processing is carried out satisfactorily.

2.2. Advantages of Substrate Processing Apparatus of Second Preferred Embodiment

Thus, in the substrate processing apparatus 1 of the second preferred embodiment, switching of the upper circulating process and the inside circulating process can be effected based on the height of liquid level of sulfuric acid stored in the external bath 20 (or the storage capacity of sulfuric acid stored in the external bath 20).

With this construction, from the point of view of the overall solution change processing, the flow resistance of sulfuric acid exerted by the filter 64 can be reduced to thereby to increase the circulation velocity of sulfuric acid. As in the case with the first preferred embodiment, this permits a reduction in the time needed to control the temperature of sulfuric acid to a predetermined value, allowing for a reduction in the time required for the solution change processing. Additionally, in a substrate processing such as cleaning process, the filter 64 can remove contaminant such as particles contained in sulfuric acid, so that the substrate processing is carried out satisfactorily.

### Third Preferred Embodiment

A third preferred embodiment of the present invention will be described below. A substrate processing apparatus of the third preferred embodiment is similar to that of the second preferred embodiment, except for an object from which obtained is an index value to be referred to at the time of switching between the upper circulating process and the inside circulating process.

Specifically, switching of the above two circulating processes is effected based on the storage capacity of sulfuric acid 25 that is supplied from a sulfuric acid supplying source 41, and that overflows a processing bath 10 and then stored in an external bath 20. Moreover, it is possible to find a certain correspondence between the storage capacity of sulfuric acid stored in the external bath 20 and the amount of supply of sulfuric acid supplied from a sulfuric acid supplying source 41.

Therefore, by effecting switching between the upper circulating process and the inside circulating process based on the amount of supply of sulfuric acid supplied from the sulfuric acid supplying source 41, the flow resistance of sulfuric acid exerted by a filter 64 can be reduced to thereby increase the circulation velocity of sulfuric acid, from the point of view of the overall solution change processing. As in the case with the first and second preferred embodiments, this permits a reduction in the time needed to control the temperature of sulfuric acid to a predetermined value, allowing for a reduction in the time required for the solution change processing.

Additionally, in a substrate processing such as cleaning process, the filter 64 can remove contaminant such as particles contained in sulfuric acid, so that the substrate processing is carried out satisfactorily.

### Fourth Preferred Embodiment

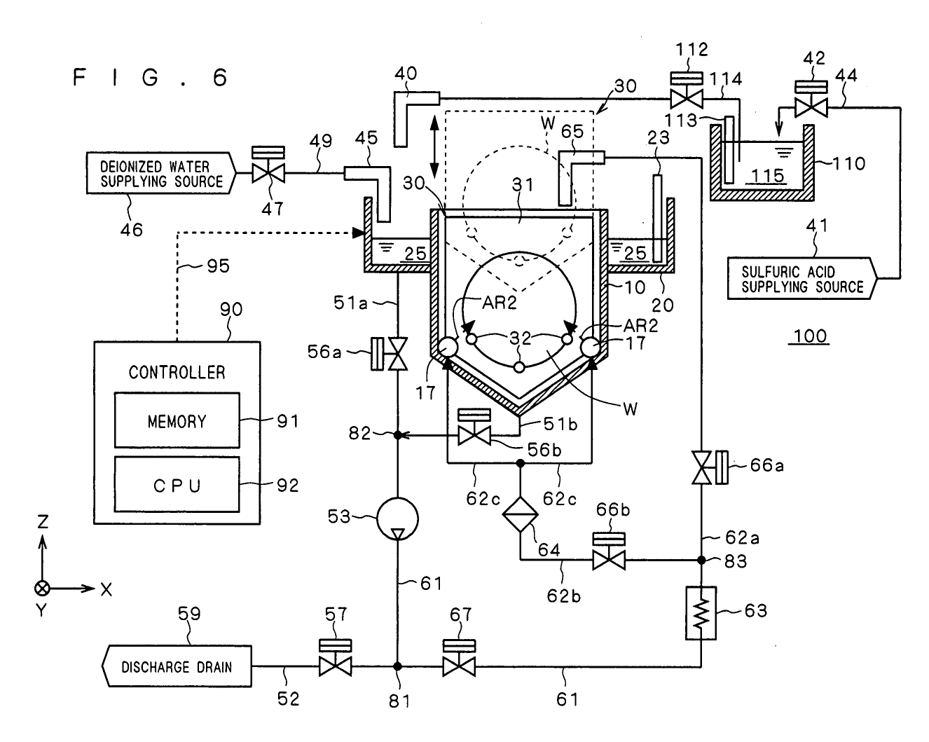

A fourth preferred embodiment of the present invention will be described below. A substrate processing apparatus 100 of the fourth preferred embodiment is similar to the substrate processing apparatus 1 of the first preferred embodiment, except that a weighing bath 110 for weighing sulfuric acid supplied from a sulfuric acid supplying source 41 is interposed between a sulfuric acid supplying source 41 and a supplying nozzle 40, as shown in FIG. 6; and that a different procedure is employed in the solution change processing. These differences will mainly be described below.

In the following description, similar components have similar reference numerals as in the substrate processing apparatus 1 of the first preferred embodiment. The descriptions of these similar components are left out of the following because they have already been described in the first preferred embodiment.

4.1. Construction of Substrate Processing Apparatus

FIG. 6 is a diagram showing one example of the construction of the substrate processing apparatus 100 according to the fourth preferred embodiment of the present invention. Referring to FIG. 6, piping 44 has a valve 42 that can be opened and closed, and communicates with the sulfuric acid supplying source 41. By controlling opening and closing of a valve 42, a predetermined amount of sulfuric acid 115 can be stored in the weighing bath 110. In the fourth preferred embodiment, the weighing bath 110 stores sulfuric acid in an amount necessary for performing a substrate processing in a processing bath 10.

One end of piping 114 communicates with a supplying nozzle 40, and the other end communicates with an inside region of the weighing bath 110, as shown in FIG. 6. The piping 114 is further provided with a valve 112 that can be opened and closed. The sulfuric acid stored in the weighing bath 110 can be supplied to an external bath 20 by controlling opening and closing of the valve 112.

Disposed inside of the external bath 20 is a level sensor 113 that can detect the height of liquid level of the sulfuric acid 115 stored in the weighing bath 110, as shown in FIG. 6. Thus, a predetermined processing is carried out based on the height of liquid level of the sulfuric acid 115 as a detected value of the level sensor 113, or the amount of sulfuric acid supplied to the external bath 20, which can be calculated from the height of liquid level detected by the level sensor 113.

4.2. Procedure of Solution Change Processing

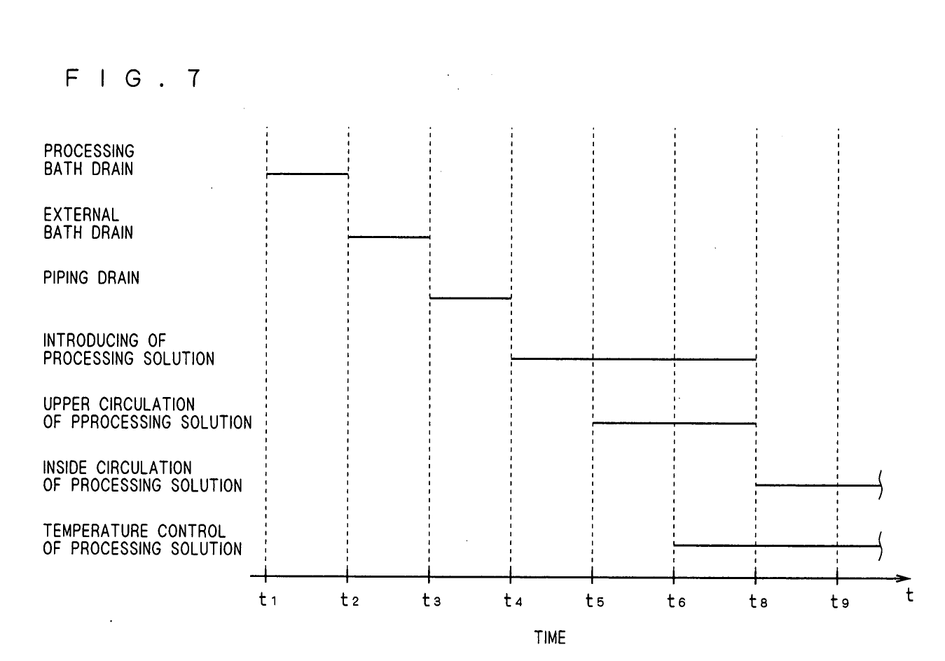

FIG. 7 is a timing chart for the purpose of explaining a solution change processing of a processing solution in the fourth preferred embodiment. The procedure of a solution change processing will be described here by mainly referring to FIGS. 6 and 7.

The following is the process of changing deionized water stored in the processing bath 10 at any point before time t1 for sulfuric acid. Assuming that, at the point before time t1 in FIG. 7, a substrate W has been moved up and down in the Z-axis direction and transferred to a transport robot (not shown) by an elevating mechanism 30; and that in the following the temperature of sulfuric acid introduced from the sulfuric acid supplying source 41 is nearly room temperature.

Like the first preferred embodiment, in the solution change processing, deionized water 15 stored in the processing bath 10 is drained at time t1 to t2, deionized water 25 recovered by the external bath 20 is drained at time t2 to t3, and deionized water remaining in first piping 62a and second piping 62b and 62c are drained at time t3 to t4, to a discharge drain 59, respectively.

At time t4, opening the valve 112 enables the sulfuric acid 115 stored in the weighing bath 110 to be supplied from a supplying nozzle 40 via the piping 114 to the external bath 20. The supply of sulfuric acid is continued until time t8, at which the supply of all of the sulfuric acid 115 stored in the weighing bath 110 is completed.

Subsequently, like the first to third preferred embodiments, the upper circulating process is started at time t5, at which it is judged that the height Z of liquid level of the sulfuric acid stored in the external bath 20 reached Z1 (the liquid level indicated by the solid line in FIG. 3), based on a detected value of the level sensor 23. Temperature control process by the temperature controller 63 is started at time t6, at which it is judged that the height Z of liquid level of the sulfuric acid stored in the external bath 20 reached Z2 (the liquid level indicated by the dotted line in FIG. 3), based on a detected value of the level sensor 23.

After the temperature control process is started, the supply of sulfuric acid to the external bath 20 is continued, and the upper circulating process is also continued. If the amount of sulfuric acid discharged from the external bath 20 and supplied to the processing bath 10 exceeds a maximum storage capacity of the processing bath 10, sulfuric acid overflows the processing bath 10, and it is recovered by the external bath 20.

Subsequently, switching from the upper circulating process to the inside circulating process is effected at time t8, at which it is judged that all of the sulfuric acid 115 stored in the weighing bath 110 has been supplied to the external bath 20, based on a detected value of the level sensor 113.

Specifically, in the fourth preferred embodiment, the flow rate per unit time of sulfuric acid supplied from the supplying nozzle 40, the circulation velocity of sulfuric acid by the pump 53, and the amount of heat supplied per unit time from the temperature controller 63 are predetermined, such that the temperature of sulfuric acid stored in the processing bath 10 is controlled to a predetermined temperature (for example, about 80° C. as in the case with the first preferred embodiment), at time t8, at which it is determined by the level sensor 113 that the supply of sulfuric acid to the external bath 20 is completed.

With this construction, from the point of view of the overall solution change processing, the flow resistance of sulfuric acid exerted by a filter 64 can be reduced to thereby increase the circulation velocity of sulfuric acid. This permits a reduction in the time needed to raise the temperature of the sulfuric acid supplied to the external bath 20 to a predetermined value, allowing for a reduction in the time required for the solution change processing.

By continuing the inside circulating process, the solution change processing is completed at time t9, at which the temperature of the sulfuric acid 15 stored in the processing bath 10 has been raised to a temperature enabling a substrate processing.

Even at the point after time t9 that a substrate processing is carried out after the solution change processing, the inside circulating process is continuously carried out. This enables the sulfuric acid overflowing the processing bath 10 to be recovered by the external bath 20 and then discharged from the external bath 20. At this time, the temperature controller 63 provided on a circulation path transmits thermal energy to sulfuric acid, so that the sulfuric acid can be retained at a predetermined temperature.

The inside circulating process via the filter 64 is employed when a substrate processing is carried out in the processing bath 10. This enables the filter 64 to remove contaminant such as particles contained in sulfuric acid, so that the substrate processing is carried out satisfactorily.

4.3. Advantages of Substrate Processing Apparatus of Fourth Preferred Embodiment

Thus, in the substrate processing apparatus of the fourth preferred embodiment, by effecting switching between the upper circulating process and the inside circulating process based on the amount of supply of sulfuric acid supplied from the sulfuric acid supplying source 41, the flow resistance of sulfuric acid exerted by the filter 64 can be reduced to thereby increase the circulation velocity of sulfuric acid, from the point of view of the overall solution change processing. As in the case with the first to third preferred embodiments, this permits a reduction in the time needed to control the temperature of sulfuric acid to a predetermined value, allowing for a reduction in the time required for the solution change processing.

Additionally, in a substrate processing such as cleaning process, the filter 64 can remove contaminant such as particles contained in sulfuric acid, so that the substrate processing is carried out satisfactorily.

Modifications

While the invention has been shown in the foregoing preferred embodiments, it is not so limited but is susceptible of various changes and modification as follows.

Firstly, although the first to fourth preferred embodiments are directed to the process of changing deionized water stored in the processing bath 10 at any point before time t1 for sulfuric acid, these embodiments are also applicable to the case of changing a processing solution stored in the processing bath 10, specifically sulfuric acid for deionized water.

In an alternative, the processing solution before and after change may be neither deionized water nor sulfuric acid. For example, phosphoric acid may be supplied as another processing solution. In this case, in consideration of a temperature at which a substrate processing with phosphoric acid is carried out (around 150 to 160° C.), and the flow resistance of phosphoric acid, the circulating process of phosphoric acid may be carried out by the upper circulating process when the temperature of phosphoric acid is not more than 130° C., and the inside circulating process when it is higher than 130° C.

Secondly, although in the first to fourth preferred embodiments, the sulfuric acid introduced from the sulfuric acid supplying source 41 is not preheated and its temperature is nearly room temperature, sulfuric acid controlled to a higher temperature than room temperature may be supplied to the external bath 20. In other words, the foregoing preferred embodiments can achieve the object of the present invention when a processing solution having a lower temperature than the temperature suitable for a substrate processing is supplied to the external bath 20.

Thirdly, the first to fourth preferred embodiments effect switching from the upper circulating process to the inside circulating process at the time the temperature of sulfuric acid, the storage capacity of sulfuric acid stored in the external bath 20, and the supply of sulfuric acid to the external bath 20 are greater than a predetermined value. In an alternative, the upper circulating process may be carried out in the region under their respective predetermined values, and the upper circulating process may be stopped and only the inside circulating process may be employed when exceeding their respective predetermined values.

In this case, in the region under their respective predetermined values, a processing solution flows through mainly the first piping 62a having a low flow resistance. It is therefore possible to increase the circulation velocity of the processing solution and reduce the time necessary for the solution change processing, than the conventional circulating process in which a processing solution passes through only a filter in such a temperature range that flow resistance is large.

Fourthly, in the second and third preferred embodiments, the upper circulating process is changed to the inside circulating process before the supply of sulfuric acid from the supplying nozzle 40 is completed, as shown in FIG. 4. As in the case with the fourth preferred embodiment, switching of the two circulating processes may be effected at the completion of the supply of sulfuric acid.

Fifthly, in the fourth preferred embodiment, the upper circulating process is changed to the inside circulating process when it is judged that all of the sulfuric acid 115 stored in the weighing bath 10 has been supplied to the external bath 20. Before all of the sulfuric acid 115 stored in the weighing bath 110 has been supplied to the external bath 20, the temperature of sulfuric acid circulating from the external bath 110 to the processing bath 10 can be raised to such a temperature range that the filter 64 has a low flow resistance, by controlling the flow rate per unit time of sulfuric acid supplied from the sulfuric acid supplying nozzle 40, the circulation velocity of sulfuric acid by the pump 53, and the amount of heat supplied per unit time from the temperature controller 63. In this case, switching of the two circulating processes may be effected based on the height of liquid level of the sulfuric acid 115 detected by the level sensor 113.

While the invention has been shown and described in detail, the foregoing description is in all aspects illustrative and not restrictive. It is therefore understood that numerous modifications and variations can be devised without departing from the scope of the invention.

What is claimed is:

1. A substrate processing apparatus that performs a processing of a substrate, comprising:
a processing bath that can store a processing solution and contain a substrate;
an external bath that is disposed outside of the processing bath and recovers the processing solution overflowing the processing bath;
common piping that is used to discharge the processing solution from the external bath;
first piping that is connected to the common piping and supplies to the processing bath the processing solution discharged via the common piping;
second piping that is connected to the common piping and supplies to the processing bath the processing solution discharged via the common piping;
a switching part that performs switching of a flow of the processing solution between the first piping and the second piping;
a temperature controller that is disposed on the common piping and controls a temperature of the processing solution flowing through the common piping;
a filter disposed on the second piping;
a temperature measuring part that measures the temperature of the processing solution; and
a controller that, when a temperature of the processing solution measured by the temperature measuring part is not greater than a predetermined temperature, controls the switching part so that the processing solution is supplied from the common piping to the processing bath via the first piping, while causing the temperature controller to heat the processing solution, and that, when a temperature of the processing solution measured by the temperature measuring part exceeds a predetermined value, controls the switching part so that the processing solution is supplied from the common piping to the processing bath via the second piping, while causing the temperature controller to heat the processing solution.

2. The substrate processing apparatus according to claim 1, further comprising:
a processing solution supplying part that supplies the processing solution to the external bath.

3. The substrate processing apparatus according to claim 2 wherein
the temperature measuring part measures the temperature of the processing solution stored in the external bath.

4. A substrate processing apparatus that performs a processing of a substrate, comprising:
a processing bath that can store a processing solution and contain a substrate;
an external bath that is disposed outside of the processing bath and recovers the processing solution overflowing the processing bath;
a processing solution supplying part that supplies the processing solution to the external bath;
common piping that is used to discharge the processing solution from the external bath;
first piping that is connected to the common piping and supplies to the processing bath the processing solution discharged via the common piping;
second piping that is connected to the common piping and supplies to the processing bath the processing solution discharged via the common piping;
a switching part that performs switching of a flow of the processing solution between the first piping and the second piping;
a temperature controller that is disposed on the common piping and controls a temperature of the processing solution flowing through the common piping;
a filter disposed on the second piping;
a storage amount detecting part that detects an amount of storage of the processing solution stored in the external bath; and
a controller that, when an amount of storage of the processing solution detected by the storage amount detecting part is not greater than a predetermined amount, controls the switching part so that the processing solution is supplied from the common piping to the processing bath via the first piping, while causing the temperature controller to heat the processing solution, and that, when an amount of storage of a processing solution detected by the storage amount detecting part exceeds a predetermined value, controls the switching part so that the processing solution is supplied from the common piping to the processing bath via the second piping, while causing the temperature controller to heat the processing solution.

5. A substrate processing apparatus that performs a processing of a substrate, comprising:
a processing bath that can store a processing solution and contain a substrate;
an external bath that is disposed outside of the processing bath and recovers the processing solution overflowing the processing bath;
a processing solution supplying part that supplies the processing solution to the external bath;
a supply amount measuring part that measures an amount of supply of the processing solution supplied from the processing solution supplying part to the processing bath;
common piping that is used to discharge the processing solution from the external bath;
first piping that is connected to the common piping and supplies to the processing bath the processing solution discharged via the common piping;
second piping that is connected to the common piping and supplies to the processing bath the processing solution discharged via the common piping;
a switching part that performs switching of a flow of the processing solution between the first piping and the second piping;
a temperature controller that is disposed on the common piping and controls a temperature of the processing solution flowing through the common piping;
a filter disposed on the second piping; and
a controller that, when an amount of supply of the processing solution measured by the supply amount measuring part is not greater than a predetermined amount, controls the switching part so that the processing solution is supplied from the common piping to the processing bath via the first piping, while causing the temperature controller to heat the processing solution, and that, when an amount of supply of the processing solution measured by the supply amount measuring part exceeds a predetermined value, controls the switching part so that the processing solution is supplied from the common piping to the processing bath via the second piping, while causing the temperature controller to heat the processing solution.

6. The substrate processing apparatus according to claim 1 wherein,
the switching part has a first valve disposed on the first piping and a second valve disposed on the second piping, and
the controller controls open and close states of the first valve and the second valve.

7. The substrate processing apparatus according to claim 6, further comprising:
a first nozzle that is connected to the first piping and supplies the processing solution from above the processing bath, and
a second nozzle that is connected to the second piping and provided in the processing bath.
